(19) United States
(12) Patent Application Publication
(10) Pub. No.: US 2026/0004104 A1
(43) Pub. Date: Jan. 1, 2026

(54) HIERARCHICAL AND PEER PRUNING STRATEGIES FOR GENERATIVE ARTIFICIAL INTELLIGENCE MODELS IN TELECOMMUNICATIONS NETWORKS

(71) Applicant: INTERNATIONAL BUSINESS MACHINES CORPORATION, ARMONK, NY (US)

(72) Inventors: Dinesh C. Verma, New Castle, NY (US); Sagar Tayal, Ambala City (IN)

(21) Appl. No.: 18/754,313

(22) Filed: Jun. 26, 2024

(51) Int. Cl. G06N 3/045; G06N 3/08

(52) U.S. Cl. CPC G06N 3/045; G06N 3/08

(57) ABSTRACT

Provided are a method, system, and computer program product for hierarchical inference utilizing a large language model (LLM). Training is performed at a central location, of a helper model and a pruned model for each layer of a hierarchy, wherein the helper model is trained to classify a request as appropriate for the pruned model, and wherein the pruned model is generated from a reduction process of the LLM. A process distributes the helper model and pruned model to different levels of the hierarchy. The process directs, by utilizing the helper model at each level of the hierarchy, inference generation to the pruned model or to another model at a higher tier.

### BACKGROUND

Embodiments relate to a method, system, and computer program product for hierarchical and peer pruning strategies for generative artificial intelligence models in telecommunications networks.

A large language model (LLM) is a language machine learning model that may be used for its ability to achieve general-purpose language generation and understanding. LLMs acquire such abilities by learning statistical relationships from text documents during a computationally intensive self-supervised and semi-supervised training process. LLMs may use artificial neural networks, some of which may be built via a transformer-based architecture. In the transformer-based architecture, a transformer is a deep learning architecture based on a multi-head attention mechanism.

Generative artificial intelligence is artificial intelligence (AI) capable of generating text, images, videos, or other data using generative models, often in response to prompts. Generative AI models learn the patterns and structure of their input training data and then generate new data that has similar characteristics. Improvements in transformer-based deep neural networks, particularly LLMs, have been instrumental in the development of generative AI systems. Generative AI may be used in generating diverse content types beyond text, including images, video, audio, code, etc. On the other hand, LLMs are generally used for text-based activities s such as natural language understanding, text generation, language translation, textual analysis, etc. Retrieval Augmented Generation (RAG) for generative AI is a pattern that pairs prompts with real-time external data to remove LLM responses.

A telecommunications network is a group of nodes interconnected by telecommunications links that may be used to exchange messages between the nodes. The links may use a variety of technologies based on the methodologies of circuit switching, message switching, or packet switching, to pass messages and signals. An example of a telecommunications network is a mobile telephony network where mobile devices communicate with cell towers and then communications continue to higher level telephony servers. The nodes may be arranged hierarchically in a telecommunications network. In the Long Term Evolution (LTE) network architecture, eNodeB, or evolved NodeB, is a critical component that may function as the base station for LTE cellular networks.

### SUMMARY

Provided are a method, system, and computer program product for hierarchical inference utilizing a large language model (LLM). Training is performed at a central location, of a helper model and a pruned model for each layer of a hierarchy, wherein the helper model is trained to classify a request as appropriate for the pruned model, and wherein the pruned model is generated from a reduction process of the LLM. A process distributes the helper model and pruned model to different levels of the hierarchy. The process directs, by utilizing the helper model at each level of the hierarchy, inference generation to the pruned model or to another model at a higher tier.

In certain embodiments, helper models are used in the hierarchy to accelerate processing at an edge computing node.

In additional embodiments, different helper models and differently pruned models are used at each layer of the hierarchy.

In further embodiments, a combination of helper models with caching of relevant documents is performed.

In certain embodiments, LLM-specific caching at the edge is performed.

In additional embodiments, peer nodes are used for inference prior to a hierarchically higher node.

In yet additional embodiments, a caching strategy for local documents is performed.

In further embodiments, documents with higher relevance scores to a request are cached at different locations.

### BRIEF DESCRIPTION OF THE DRAWINGS

Referring now to the drawings in which like reference numbers represent corresponding parts throughout:

FIG. 1 illustrates a block diagram of a computing environment, in accordance with certain embodiments.

FIG. 2 illustrates a block diagram that shows training and distribution processes, in accordance with certain embodiments.

FIG. 3 illustrates a block diagram that shows a level up inference process, in accordance with certain embodiments.

FIG. 4 illustrates a block diagram that shows an inference process with caching document relevance, in accordance with certain embodiments.

FIG. 5 illustrates a block diagram that shows an inference process with peers and level up nodes, in accordance with certain embodiments.

FIG. 6 illustrates a block diagram that shows a training process, in accordance with certain embodiments.

FIG. 7 illustrates a flow chart for pruning strategies for generative AI models, in accordance with certain embodiments.

FIG. 8 illustrates a computing environment in which certain components may be implemented, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

Several examples will now be provided to further clarify various aspects of the present invention:

Example 1: A method for hierarchical inference utilizing a large language model (LLM) in which training is performed at a central location, of a helper model and a pruned model for each layer of a hierarchy, where the helper model is trained to classify a request as appropriate for the pruned model, and where the pruned model is generated from a reduction process of the LLM. A process distributes the helper model and pruned model to different levels of the hierarchy. The process directs, by utilizing the helper model at each level of the hierarchy, inference generation to the pruned model or to another model at a higher tier. As a result, processing performance is improved in a telecommunications network.

Example 2: The limitations of Example 1, where helper models are used in the hierarchy to accelerate processing at an edge computing node. As a result, processing performance is improved in an edge computing node.

Example 3: The limitations of any of Examples 1-2, where different helper models and differently pruned models are used at each layer of the hierarchy. As result processing performance is improved in each layer of the hierarchy.

Example 4: The limitations of any of Examples 1-3, where a combination of helper models with caching of relevant documents is performed. As a result, processing performance may be increased via caching in a telecommunications network.

Example 5: The limitations of any of Examples 1-4, where LLM-specific caching at the edge is performed. As a result, caching may be used to improve performance at the edge of a telecommunications network.

Example 6: The limitations of any of Examples 1-5, where peer nodes are used for inference prior to a hierarchically higher node. As a result, peer processing may be used to improve processing performance in a telecommunications network.

Example 7: The limitations of any of Examples 1-6, where a caching strategy for local documents is performed. As a result, the caching of local documents is used to improve performance in a telecommunications network.

Example 8: The limitations of any of Examples 1-7, where documents with higher relevance scores to a request are cached at different locations. As a result, relevance scores are used to improve processing performance in a telecommunications network.

Example 9: A system comprising a memory and a processor coupled to the memory, where the processor performs a method according to any of Examples 1-8. As a result, processing performance is improved in telecommunications networks.

Example 10: A computer program product comprising a computer readable storage medium having computer readable program code embodied therewith, where the computer readable program code when executed is configured to perform a method according to any of Examples 1-8. As a result, processing performance is improved in a telecommunications network.

Implementation of generative AI (e.g., based on LLMs) is important for advanced decision-making in telecommunications networks. Such implementations may enable intelligent responses, data analysis, and automated processes, thereby enhancing overall operational efficiency in the telecommunications network.

Examples of generative AI utility may include quick fault maintenance in which rapid identification and resolution of network faults are determined through automated analysis. Real-time responses to potential issues may be made, minimizing downtime and improving service reliability in the telecommunications networks.

However, telecommunication networks may have limited resources at cell-tower sites. For example, cell-tower site computational units, including Radio Unit (RU), Central Units (CU), Distributed Units (DU), and enodeBs frequently operate with constrained computational resources. In addition, a cell-tower site may serve as a high-speed data switch that interfaces with User Equipment (UE) devices and the core network infrastructure. Deploying resource-intensive generative AI models at these cell-tower sites may strain limited resources, leading to potential performance bottlenecks and service disruptions.

Additionally, telecommunications networks may have to address latency and real-time processing issues. For example, telecommunication networks may have requirements of real-time decision-making for low latency and optimal service delivery. Generative AI models implemented at centralized locations may introduce delays in decision-making processes, potentially impacting the ability to meet stringent latency requirements crucial for telecommunications operations.

Furthermore, telecommunication networks may have to address network efficiency and bandwidth considerations. For example, telecommunications networks may have to optimize network bandwidth for seamless communication. Implementing resource-heavy generative AI models may increase data transfer demands, affecting overall network efficiency and potentially leading to escalated costs.

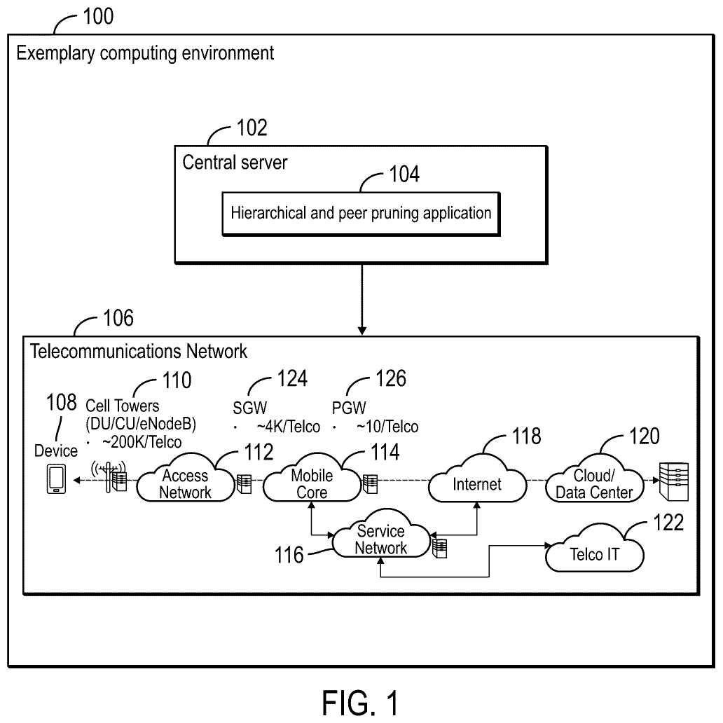

FIG. 1 illustrates a block diagram of an exemplary computing environment 100, in accordance with certain embodiments.

A central server 102 that executes a hierarchical and peer pruning application 104 for generative AI models is coupled to a telecommunications network 106. In certain alternative embodiments, the central server 102 may be included within the telecommunications network 106. Certain embodiments of the invention are implemented in the central server 102.

The central server 102 may in certain embodiments comprise any suitable computational device known in the art such as a server, a personal computer, a laptop, a mainframe, etc.

Many components of the telecommunications network 106 are shown in FIG. 1. Such components include a device 108 (e.g., a cell phone) coupled to cell towers 110, access networks 112, and mobile cores 114 coupled directly or indirectly to service networks 116, the Internet 118, cloud-based data centers 120, and telecommunications information technology systems 122 as shown in FIG. 1. In the telecommunications network 106, servers become less powerful as one reaches from the data centers 120 towards the cell towers 110. Servers become greater in number as one moves from the data centers 120 to mobile core 114 towards the cell towers 110. For example, serving gateway (SGW) 124 and Packet gateway (PGW) 126 that are network nodes of LTE corresponding to the access networks 112 and the mobile core 114 are also shown schematically in FIG. 1. In certain embodiments there may be around 200K cell towers 110, but around 4K SGWs and 10 PGWs.

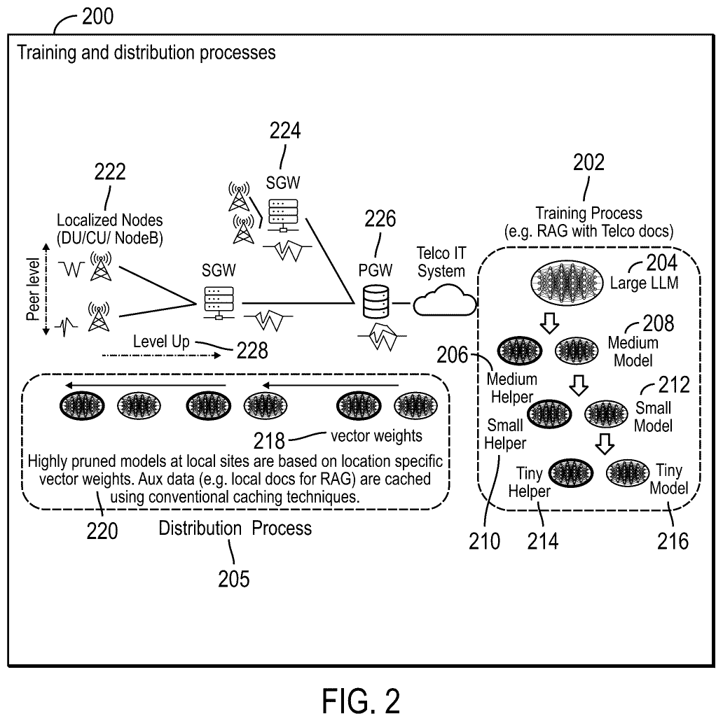

FIG. 2 illustrates a block diagram 200 that shows training and distribution processes, in accordance with certain embodiments. The training process 202 and the distribution process 205 may be implemented in the central server 102 shown in FIG. 1 via the hierarchical and peer pruning application 104.

In the training process 202 a large LLM 204 may be used to generate a medium helper 206 and a medium model 208, a small helper 210 and a small model 212, and a tiny helper 214 and a tiny model 216. The training process 202 may comprise Retrieval Augmented Generation (RAG) with telecommunications specific telecommunications documents. The medium model 208, the small model 212, and the tiny model 216 may be referred to as pruned models of the large model 204.

In the distribution process 205, highly pruned models at local sites (e.g., cell tower sites) are based on location specific vector weights 218. Aux data (e.g. local documents for RAG) are cached using conventional caching techniques (as shown via reference numeral 220).

Therefore, in certain embodiments, the tiny helper 214 and the tiny model 216 may be distributed to localized nodes 222, the small helper 210 and the small model 212 may be distributed to SGW nodes 224, and the medium helper 206 and medium model 208 may be distributed to PGW nodes 226, where the localized nodes are greater in number than SGW nodes which are greater in number than PGW nodes, and where the localized nodes have lower processing power than SGW nodes which have less processing power than PGW nodes. The hierarchical level goes up from localized node to SGW nodes to PGW nodes as shown via reference numeral 228.

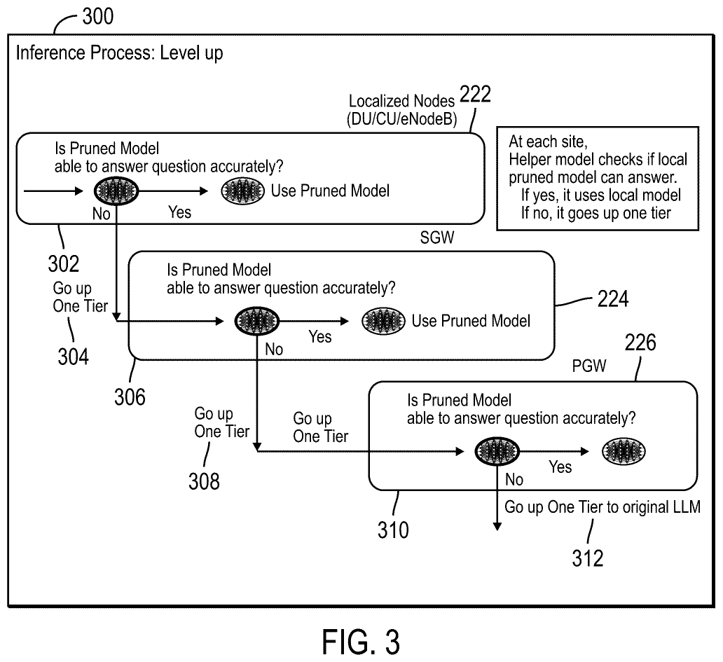

FIG. 3 illustrates a block diagram 300 that shows a level up inference process, in accordance with certain embodiments.

In FIG. 3, at each site, the helper model checks if the local pruned model can answer a question accurately. If so, the process uses a local model to answer a question and if not, the process goes up one tier in an attempt to answer the question.

For example, at a localized node 222, the tiny helper 214 of the localized node 222 may check if the pruned model (e.g., the tiny model 216) is able to answer a question correctly. If so, the localized node 222 uses the tiny model 216 to answer the question, else the process goes to the next level (i.e., next tier) to the SGW 224 in an attempt to answer the question [as shown via reference numerals 302, 304].

Similar processes occur in the SGW 224 and PGW 226 as shown via reference numerals 306, 308, 310, 312. Therefore, the query goes to the original LLM 204 which is the original and not a pruned model, if at the PGW node 226, the helper (e.g., medium helper 206) of the PGW node 226 determines that that pruned model (e.g., medium model 208) is unable to answer the question. Documents with higher relevance scores to a request are cached at different locations as shown via reference numerals 412, 414.

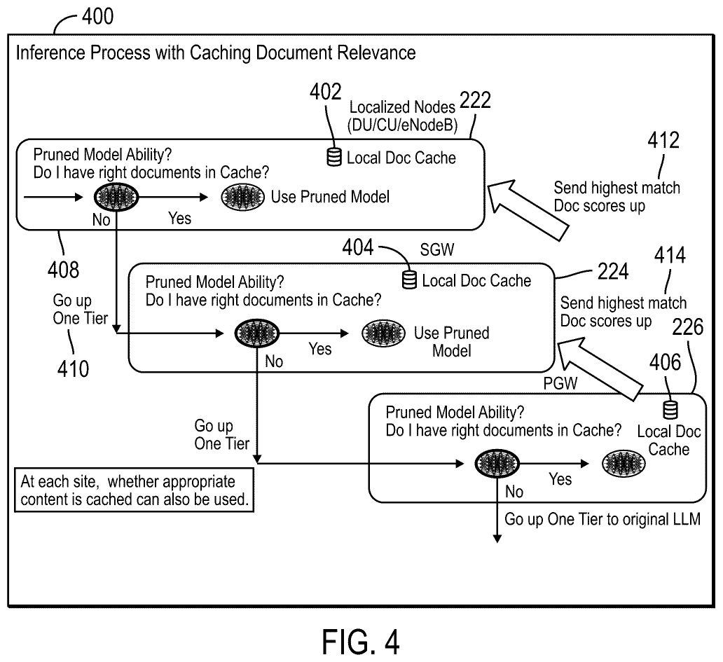

FIG. 4 illustrates a block diagram 400 that shows an inference process with caching document relevance, in accordance with certain embodiments.

At each site, a local document cache is maintained. At each site, whether appropriate content is cached may also be used for processing by the pruned model at the site. If the right documents are not found in the cache, the process goes up one tier.

For example, different local document cache 402, 404, 406 are placed in localized node 222, SGW node 224, and PGW node 226 respectively. If at the localized node 222, the pruned model has the appropriate content in the local document cache 402, then the pruned model is used for answering the question, and otherwise the process goes up one tier to the SGW node in an attempt to answer the question (as shown via reference numerals 408, 410). Similar operations are performed in the SGW node 224 and the PGW node 226.

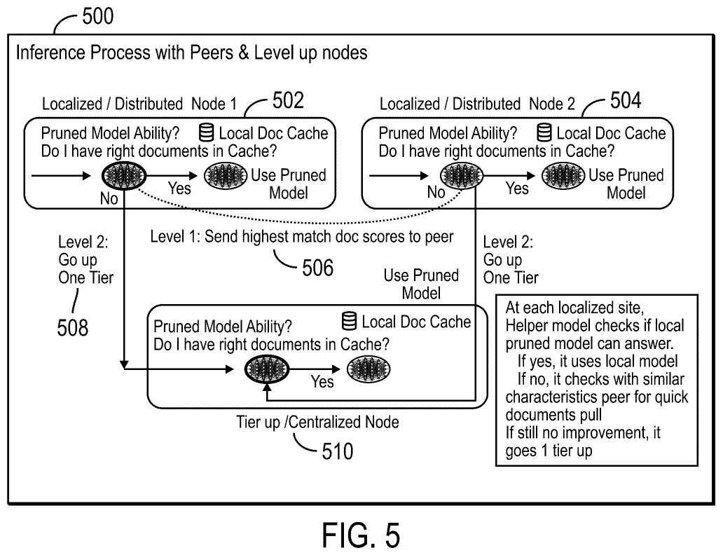

FIG. 5 illustrates a block diagram 500 that shows an inference process with peers and level up nodes, in accordance with certain embodiments.

In FIG. 5, some or all nodes comprising the localized nodes 222 may be peers of each other and shown via reference numerals 502, 504.

In certain embodiments, at each localized site, the helper model checks if the local pruned model can answer a question. If so, the process uses the local model. If not, the process checks with a similar characteristics peer (i.e., a peer node having similar characteristics) for quick documents pull as shown via reference numeral 506. If still there is no improvement, the process goes one tier up (as shown via reference numeral 508). Ultimately the centralized node 510 (i.e., the central server 102) may be used to answer the question.

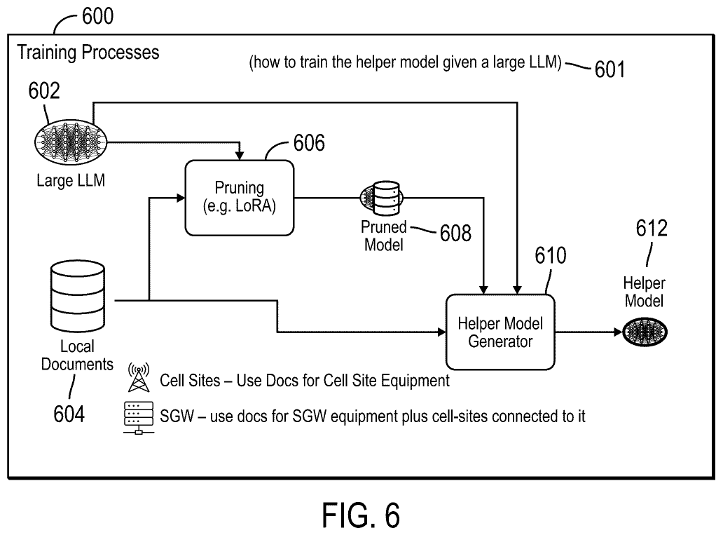

FIG. 6 illustrates a block diagram 600 that shows a training process to train the helper model given a large LLM (as shown via reference numeral 601), in accordance with certain embodiments.

In certain embodiments, a large LLM 602 and local documents 604 are used by a pruning application 606 to generate a pruned model 608. A helper model generator 610 may generate the helper model 612. FIG. 6 also shows that documents are used by components such as cell sites and SGWs.

In certain embodiments, hierarchical inference utilizing a large language model (LLM) is performed. Training is performed at a central location, of a helper model and a pruned model for each layer of a hierarchy, wherein the helper model is trained to classify a request as appropriate for the pruned model, and wherein the pruned model is generated from a reduction process of the LLM. A process distributes the helper model and pruned model to different levels of the hierarchy. The process directs, by utilizing the helper model at each level of the hierarchy, inference generation to the pruned model or to another model at a higher tier.

The model pruning and document caching across diverse domains and peer collaboration offer at least the following improvements:
(1) Bidirectional Adaptability in which the methodology is not confined to top-down (north-south) data flows; it seamlessly adapts to bidirectional (east-west) data exchanges. Peers with similar characteristics can offer valuable insights into optimizing pruned models and identifying relevant documents for caching within the system.
(2) Peer Collaboration for Model Optimization: Collaborative efforts among peers facilitate the exchange of insights regarding the performance of different pruned model versions. This collaborative approach significantly enhances the overall efficiency and effectiveness of pruning model deployment across the network.
(3) Cross-Industry Applicability: Beyond the telecommunications sector, this methodology holds relevance across diverse industries such as manufacturing, healthcare and others. Its broad applicability addresses various challenges associated with LLM pruning, offering versatile solutions across industries.

For training the helper medal a process performs the following: Start from a LLM model for a task and fine-tune it using local documents (model at highest hierarchy).

Several LLM Pruning strategies exist-with tunable parameters (e.g., LLM Pruning using prunes models using LoRA given a set of documents. Processes can select different set of documents (e.g., cell-tower docs/PGW docs) to prune different levels.

For each level in the hierarchy the process performs the following:
1. Create a pruned model from the model at upper or peer level of hierarchy which would be smaller or more efficient for inference
2. Use the pruned model to classify test input data set into ones where pruned model gives same answer as large/efficient model (pruned model is appropriate) and whether the pruned model gives a different answer (pruned model is not appropriate)
3. Use the data thus classified to train a helper model (binary classifier) that determines if a request is ‘appropriate’ or not
4. Another option is to cluster embeddings of documents into regions which produce close answers, and which do not.

Certain embodiments involve deploying generative AI models strategically in a telecommunication network.

Starting with an unpruned model at a centralized site, processes progressively introduce moderately pruned models at intermediate sites and highly pruned models at local sites.

Processes train a fitness model which can predict whether the pruned model would be good at performing the task on a specific input.

The initial pruning process, guided by telco-specific or vendor-specific criteria and incorporating vector weights, ensures efficiency.

This custom-made pruning allows each localized site to refine its model based on specific behavior and requirements, contributing to a responsive and resource-efficient network.

The fitness model allows processes to rapidly identify cases whether the pruned model may not perform as well, and leverage the larger model as needed.

For AI use cases which rely on a set of documents processes couple the model inference with a strategy for caching documents. Documents are cached according to their matching score to satisfy the queries.

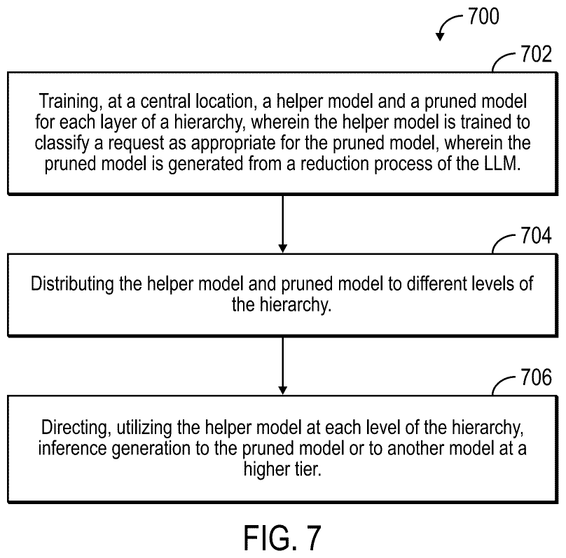

FIG. 7 illustrates a flowchart 700 for pruning strategies for generative AI models, in accordance with certain embodiments. The operations shown in flowchart 7 may be performed under the control of the central server 102.

Control starts at block 702 in which training is performed at a central location, of a helper model and a pruned model for each layer of a hierarchy, wherein the helper model is trained to classify a request as appropriate for the pruned model, and wherein the pruned model is generated from a reduction process of the LLM.

From block 702 control proceeds to block 704 in which a process distributes the helper model and pruned model to different levels of the hierarchy. The process directs (at block 706), by utilizing the helper model at each level of the hierarchy, inference generation to the pruned model or to another model at a higher tier.

Therefore, FIGS. 1-7 illustrate certain embodiments for hierarchical and peer pruning strategies for generative artificial intelligence models in telecommunications networks. This results in an improvement in processing operations in the telecommunications networks.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

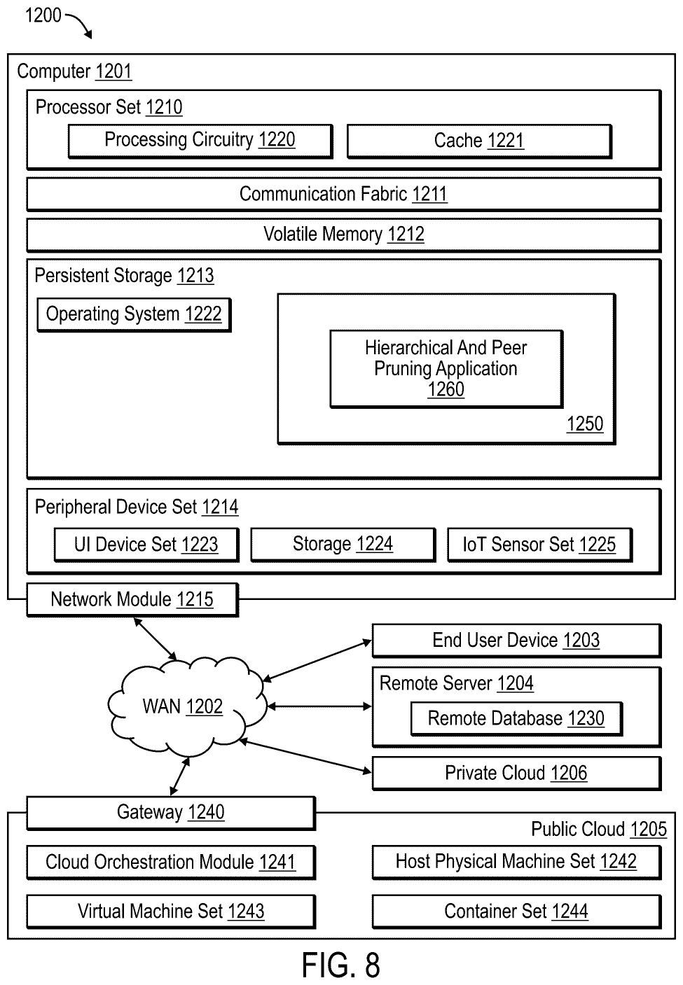

In FIG. 8, a computing environment 1200 contains an example of an environment for the execution of at least some of the computer code (block 1250) involved in performing the operations of an application for hierarchical and peer pruning application 1260 that performs operations shown in FIGS. 1-7.

In addition to block 1250, computing environment 1200 includes, for example, computer 1201, wide area network (WAN) 1202, end user device (EUD) 1203, remote server 1204, public cloud 1205, and private cloud 1206. In this embodiment, computer 1201 includes processor set 1210 (including processing circuitry 1220 and cache 1221), communication fabric 1211, volatile memory 1212, persistent storage 1213 (including operating system 1222 and block 1250, as identified above), peripheral device set 1214 (including user interface (UI) device set 1223, storage 1224, and Internet of Things (IoT) sensor set 1225), and network module 1215. Remote server 1204 includes remote database 1230. Public cloud 1205 includes gateway 1240, cloud orchestration module 1241, host physical machine set 1242, virtual machine set 1243, and container set 1244.

COMPUTER 1201 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1230. As is well understood in the art of computer technology, and depending upon the technology, performance of a computer-implemented method may be distributed among multiple computers and/or between multiple locations. On the other hand, in this presentation of computing environment 1200, detailed discussion is focused on a single computer, specifically computer 1201, to keep the presentation as simple as possible computer 1201 may be located in a cloud, even though it is not shown in a cloud in FIG. 12. On the other hand, computer 1201 is not required to be in a cloud except to any extent as may be affirmatively indicated.

PROCESSOR SET 1210 includes one, or more, computer processors of any type now known or to be developed in the future. Processing circuitry 1220 may be distributed over multiple packages, for example, multiple, coordinated integrated circuit chips. Processing circuitry 1220 may implement multiple processor threads and/or multiple processor cores. Cache 1221 is memory that is located in the processor chip package(s) and is typically used for data or code that should be available for rapid access by the threads or cores running on processor set 1210. Cache memories are typically organized into multiple levels depending upon relative proximity to the processing circuitry. Alternatively, some, or all, of the cache for the processor set may be located “off chip.” In some computing environments, processor set 1210 may be designed for working with qubits and performing quantum computing.

Computer readable program instructions are typically loaded onto computer 1201 to cause a series of operational steps to be performed by processor set 1210 of computer 1201 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1221 and the other storage media discussed below. The program instructions, and associated data, are accessed by processor set 1210 to control and direct performance of the inventive methods. In computing environment 1200, at least some of the instructions for performing the inventive methods may be stored in block 1250 in persistent storage 1213.

COMMUNICATION FABRIC 1211 is the signal conduction path that allows the various components of computer 1201 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1212 is any type of volatile memory now known or to be developed in the future. Examples include dynamic type random access memory (RAM) or static type RAM. Typically, volatile memory 1212 is characterized by random access, but this is not required unless affirmatively indicated. In computer 1201, the volatile memory 1212 is located in a single package and is internal to computer 1201, but, alternatively or additionally, the volatile memory may be distributed over multiple packages and/or located externally with respect to computer 1201.

PERSISTENT STORAGE 1213 is any form of non-volatile storage for computers that is now known or to be developed in the future. The non-volatility of this storage means that the stored data is maintained regardless of whether power is being supplied to computer 1201 and/or directly to persistent storage 1213. Persistent storage 1213 may be a read only memory (ROM), but typically at least a portion of the persistent storage allows writing of data, deletion of data and re-writing of data. Some familiar forms of persistent storage include magnetic disks and solid-state storage devices. Operating system 1222 may take several forms, such as various known proprietary operating systems or open-source Portable Operating System Interface-type operating systems that employ a kernel. The code included in block 1250 typically includes at least some of the computer code involved in performing the inventive methods.

PERIPHERAL DEVICE SET 1214 includes the set of peripheral devices of computer 1201. Data communication connections between the peripheral devices and the other components of computer 1201 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1223 may include components such as a display screen, speaker, microphone, wearable devices (such as goggles and smart watches), keyboard, mouse, printer, touchpad, game controllers, and haptic devices. Storage 1224 is external storage, such as an external hard drive, or insertable storage, such as an SD card. Storage 1224 may be persistent and/or volatile. In some embodiments, storage 1224 may take the form of a quantum computing storage device for storing data in the form of qubits. In embodiments where computer 1201 is required to have a large amount of storage (for example, where computer 1201 locally stores and manages a large database) then this storage may be provided by peripheral storage devices designed for storing very large amounts of data, such as a storage area network (SAN) that is shared by multiple, geographically distributed computers. I/O T sensor set 1225 is made up of sensors that can be used in Internet of Things applications. For example, one sensor may be a thermometer and another sensor may be a motion detector.

NETWORK MODULE 1215 is the collection of computer software, hardware, and firmware that allows computer 1201 to communicate with other computers through WAN 1202. Network module 1215 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1215 are performed on the same physical hardware device. In other embodiments (for example, embodiments that utilize software-defined networking (SDN)), the control functions and the forwarding functions of network module 1215 are performed on physically separate devices, such that the control functions manage several different network hardware devices. Computer readable program instructions for performing the inventive methods can typically be downloaded to computer 1201 from an external computer or external storage device through a network adapter card or network interface included in network module 1215.

WAN 1202 is any wide area network (for example, the internet) capable of communicating computer data over non-local distances by any technology for communicating computer data, now known or to be developed in the future. In some embodiments, the WAN 1202 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1203 is any computer system that is used and controlled by an end user (for example, a customer of an enterprise that operates computer 1201), and may take any of the forms discussed above in connection with computer 1201. EUD 1203 typically receives helpful and useful data from the operations of computer 1201. For example, in a hypothetical case where computer 1201 is designed to provide a recommendation to an end user, this recommendation would typically be communicated from network module 1215 of computer 1201 through WAN 1202 to EUD 1203. In this way, EUD 1203 can display, or otherwise present, the recommendation to an end user. In some embodiments, EUD 1203 may be a client device, such as thin client, heavy client, mainframe computer, desktop computer and so on.

REMOTE SERVER 1204 is any computer system that serves at least some data and/or functionality to computer 1201. Remote server 1204 may be controlled and used by the same entity that operates computer 1201. Remote server 1204 represents the machine(s) that collect and store helpful and useful data for use by other computers, such as computer 1201. For example, in a hypothetical case where computer 1201 is designed and programmed to provide a recommendation based on historical data, then this historical data may be provided to computer 1201 from remote database 1230 of remote server 1204.

PUBLIC CLOUD 1205 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1205 is performed by the computer hardware and/or software of cloud orchestration module 1241. The computing resources provided by public cloud 1205 are typically implemented by virtual computing environments that run on various computers making up the computers of host physical machine set 1242, which is the universe of physical computers in and/or available to public cloud 1205. The virtual computing environments (VCEs) typically take the form of virtual machines from virtual machine set 1243 and/or containers from container set 1244. It is understood that these VCEs may be stored as images and may be transferred among and between the various physical machine hosts, either as images or after instantiation of the VCE. Cloud orchestration module 1241 manages the transfer and storage of images, deploys new instantiations of VCEs and manages active instantiations of VCE deployments. Gateway 1240 is the collection of computer software, hardware, and firmware that allows public cloud 1205 to communicate through WAN 1202.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1206 is similar to public cloud 1205, except that the computing resources are only available for use by a single enterprise. While private cloud 1206 is depicted as being in communication with WAN 1202, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1205 and private cloud 1206 are both part of a larger hybrid cloud.

The letter designators, such as i, is used to designate a number of instances of an element may indicate a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A method for hierarchical inference utilizing a large language model (LLM), the method comprising:
training, at a central location, a helper model and a pruned model for each layer of a hierarchy, wherein the helper model is trained to classify a request as appropriate for the pruned model, wherein the pruned model is generated from a reduction process of the LLM;
distributing the helper model and pruned model to different levels of the hierarchy; and
directing, utilizing the helper model at each level of the hierarchy, inference generation to the pruned model or to another model at a higher tier.

2. The method of claim 1, the method further comprising:
using helper models in the hierarchy to accelerate processing at an edge computing node.

3. The method of claim 2, wherein different helper models and differently pruned models are used at each layer of the hierarchy.

4. The method of claim 3, wherein a combination of helper models with caching of relevant documents is performed.

5. The method of claim 4, wherein LLM-specific caching at the edge is performed.

6. The method of claim 1, wherein peer nodes are used for inference prior to a hierarchically higher node.

7. The method of claim 1, wherein a caching strategy for local documents is performed.

8. The method of claim 7, wherein documents with higher relevance scores to a request are cached at different locations.

9. A system for hierarchical inference utilizing a large language model (LLM), the system comprising:
a memory; and
a processor coupled to the memory, wherein the processor performs operations, the operations comprising:
training, at a central location, a helper model and a pruned model for each layer of a hierarchy, wherein the helper model is trained to classify a request as appropriate for the pruned model, wherein the pruned model is generated from a reduction process of the LLM;
distributing the helper model and pruned model to different levels of the hierarchy; and
directing, utilizing the helper model at each level of the hierarchy, inference generation to the pruned model or to another model at a higher tier.

10. The system of claim 9, the operations further comprising:
using helper models in the hierarchy to accelerate processing at an edge computing node.

11. The system of claim 10, wherein different helper models and differently pruned models are used at each layer of the hierarchy.

12. The system of claim 11, wherein a combination of helper models with caching of relevant documents is performed.

13. The system of claim 12, wherein LLM-specific caching at the edge is performed.

14. The system of claim 9, wherein peer nodes are used for inference prior to a hierarchically higher node.

15. The system of claim 9, wherein a caching strategy for local documents is performed.

16. The system of claim 15, wherein documents with higher relevance scores to a request are cached at different locations.

17. A computer program product for hierarchical inference utilizing a large language model (LLM), the computer program product comprising a computer readable storage medium, wherein code stored in the computer readable storage medium when executed by a processor performs operations, the operations comprising:
training, at a central location, a helper model and a pruned model for each layer of a hierarchy, wherein the helper model is trained to classify a request as appropriate for the pruned model, wherein the pruned model is generated from a reduction process of the LLM;
distributing the helper model and pruned model to different levels of the hierarchy; and
directing, utilizing the helper model at each level of the hierarchy, inference generation to the pruned model or to another model at a higher tier.

18. The computer program product of claim 17, the operations further comprising:
using helper models in the hierarchy to accelerate processing at an edge computing node.

19. The computer program product of claim 18, wherein different helper models and differently pruned models are used at each layer of the hierarchy.

20. The computer program product of claim 19, wherein a combination of helper models with caching of relevant documents is performed.

21. The computer program product of claim 20, wherein LLM-specific caching at the edge is performed.

22. The computer program product of claim 17, wherein peer nodes are used for inference prior to a hierarchically higher node.

23. The computer program product of claim 17, wherein a caching strategy for local documents is performed.

24. The computer program product of claim 23, wherein documents with higher relevance scores to a request are cached at different locations.
